(19) United States
(12) Patent Application Publication
(10) Pub. No.: US 2026/0205233 A1
(43) Pub. Date: Jul. 16, 2026

(54) Packet Transmission with Streaming Redundancy

(71) Applicant: MELLANOX TECHNOLOGIES, LTD., Yokneam (IL)

(72) Inventors: Yamin Friedman, Jerusalem (IL); Idan Burstein, Carmiel (IL); Diego Crupnicoff, Buenos Aires (AR); Ariel Shahar, Jerusalem (IL); Ori Schweitzer, Ramat Gan (IL); Weihuang Wang, Los Gatos, CA (US)

(21) Appl. No.: 19/019,562

(22) Filed: Jan. 14, 2025

(51) Int. Cl. H04L 1/1812

(52) U.S. Cl. CPC H04L 1/1819

(57) ABSTRACT

A network device includes a port, a packet pipeline, and a redundancy generator. The port is to connect to a network. The packet pipeline is to transmit a sequence of data packets to the network via the port. The redundancy generator is to, for a group of the data packets (i) initialize one or more redundancy blocks, then (ii) iteratively update the one or more redundancy blocks in response to the data packets in the group traversing the packet pipeline, and (iii) generate one or more redundancy packets comprising the one or more redundancy blocks. The redundancy generator is to transmit the one or more redundancy packets to the network using the packet pipeline.

### TECHNICAL FIELD

The present disclosure relates generally to packet communication systems, and particularly to methods and systems for transport-level redundancy.

### BACKGROUND

Reliable transport protocols, such as Remote Direct Memory Access (RDMA), typically rely on retransmission mechanisms to mitigate packet and maintain loss functional correctness. While providing high reliability, retransmission incurs considerable latency, on the order of the network Round-Trip Time (RTT). Small message latency, however, is critical in many applications, e.g., in complex Machine Learning (ML) tasks that are distributed across multiple hosts.

### SUMMARY

An embodiment that is described herein provides a network device including a port, a packet pipeline, and a redundancy generator. The port is to connect to a network. The packet pipeline is to transmit a sequence of data packets to the network via the port. The redundancy generator is to, for a group of the data packets (i) initialize one or more redundancy blocks, then (ii) iteratively update the one or more redundancy blocks in response to the data packets in the group traversing the packet pipeline, and (iii) generate one or more redundancy packets comprising the one or more redundancy blocks. The redundancy generator is to transmit the one or more redundancy packets to the network using the packet pipeline.

In some embodiments, the redundancy generator is to obtain the data packets from a transport layer of the network device. In some embodiments, the data packets in the group are associated with a given Queue Pair (QP) of the network device. In some embodiments, the redundancy generator is to update multiple sets of redundancy blocks for multiple respective groups of the data packets, including maintaining respective states for the groups.

In a disclosed embodiment, at least two of the data packets in the group differ in size from one another, and the redundancy generator is to set a size of a redundancy block to be at least a maximal size of the data packets in the group. In an example embodiment, the redundancy generator is to specify, in the one or more redundancy packets, respective sizes of the data packets in the group. In an embodiment, the redundancy generator is to include in the group data packets associated with write or send commands, and to exclude from the group data packets associated with read commands. In some embodiments, the one or more redundancy blocks include multiple redundancy blocks, and the redundancy generator is to update each of the redundancy blocks in response to a respective, different subset of the data packets in the group.

There is additionally provided, in accordance with an embodiment that is described herein, a network device including a port, a packet pipeline, and a redundancy reconstructor. The port is to connect to a network. The packet pipeline is to receive, from the network via the port, a packet sequence including multiple data packets and one or more redundancy packets. The redundancy reconstructor is to perform the following for a group of expected data packets associated with the one or more redundancy packets: (i) initialize one or more redundancy blocks, (ii) iteratively update the one or more redundancy blocks to account for any received redundancy and any received data packet belonging to the packet group, (iii) upon updating the redundancy blocks to account for the one or more redundancy packets and all but a specified number of one or more remaining data packets in the group, reconstruct the one or more remaining data packets using the one or more redundancy blocks, and (iv) provide the reconstructed one or more remaining data packets to the packet pipeline.

In some embodiments, the redundancy reconstructor is to forward the reconstructed one or more remaining data packets to a transport layer of the network device. In some embodiments, the data packets in the group are associated with a given Queue Pair (QP) of the network device.

In some embodiments, the redundancy reconstructor is to update multiple sets of redundancy blocks for multiple respective groups of the data packets, including maintaining respective states for the groups. In an example embodiment, the redundancy reconstructor is to associate a received data packet with one of the groups based on one or more identifiers extracted from the data packet.

In a disclosed embodiment, the redundancy reconstructor is to (i) extract, from the one or more redundancy packets, sizes of the respective data packets in the group, and (ii) update the one or more redundancy blocks to account for the received data packets depending on the sizes of the data packets.

In some embodiments, the one or more redundancy blocks include multiple redundancy blocks, and the redundancy reconstructor is to update each of the redundancy blocks in response to a respective, different subset of the data packets in the group.

There is further provided, in accordance with an embodiment that is described herein, a method including transmitting a sequence of data packets to a network using a packet pipeline. For a group of the data packets, one or more redundancy blocks are initialized, then the one or more redundancy blocks are iteratively updated in response to the data packets in the group traversing the packet pipeline, and one or more redundancy packets including the one or more redundancy blocks are generated. The one or more redundancy packets are transmitted to the network using the packet pipeline.

There is also provided, in accordance with an embodiment that is described herein, a method including, using a packet pipeline, receiving from a network a packet sequence including multiple data packets and one or more redundancy packets. The following is performed for a group of expected data packets associated with the one or more redundancy packets: (i) initializing one or more redundancy blocks, (ii) iteratively updating the one or more redundancy blocks to account for any received redundancy packet and any received data packet belonging to the group, (iii) upon updating the redundancy blocks to account for the one or more redundancy packets and all but a specified number of one or more remaining data packets in the group, reconstructing the one or more remaining data packets using the one or more redundancy blocks, and (iv) providing the reconstructed one or more remaining data packets to the packet pipeline.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a communication system comprising network devices that use Transport Amplified Redundancy Protocol (TARP), in accordance with an embodiment that is described herein;

FIG. 2 is a diagram that schematically illustrates integration of TARP in transport layer processing, in accordance with an embodiment that is described herein;

FIG. 3 is a diagram that schematically illustrates a sequence of data packets divided into TARP regions, in accordance with an embodiment that is described herein;

FIG. 4 is a flow chart that schematically illustrates a method for packet transmission using TARP in a requestor network device, in accordance with an embodiment that is described herein;

FIG. 5 is a flow chart that schematically illustrates a method for packet reception using TARP in a responder network device, in accordance with an embodiment that is described herein; and

FIG. 6 is a block diagram that schematically illustrates a computing system comprising network devices that use TARP, in accordance with an embodiment that is described herein.

### DETAILED DESCRIPTION OF EMBODIMENTS

### Overview

Embodiments that are described herein provide a novel protocol, referred to as Transport Amplified Redundancy Protocol (TARP), systems and network devices that employ TARP, and related methods. TARP mitigates packet loss without requiring retransmission and without incurring the latency associated with retransmission. TARP may be implemented in various network devices, e.g., Ethernet Network Interface Controllers (NICS), in InfiniBand™ (IB) Host Channel Adapters (HCAs), Data Processing Units (DPUs, also referred to as “Smart NICs”) and others.

TARP is typically integrated as part of the transport layer stack in the network device. Upper layers are thus provided with a high-reliability and low-latency transport while being unaware of the underlying redundancy operations. The embodiments described herein refer mainly to ROMA, by way of example, but the disclosed techniques can be used with various other transport protocols. In RDMA, TARP can be used in both Reliable Connections (RC) and Unreliable Connections (UC). TARP is useful in both long-RTT and short-RTT connections.

In some embodiments, a network device referred to as a “requestor” sends a sequence of data packets to a network device referred to as a “responder”. For a defined group of data packets in the sequence, referred to as a “TARP group” or “TARP region”, the requestor calculates a “redundancy block” over the data packets in the group. The requestor then generates a Redundancy Packet (RDP), which comprises the redundancy block plus relevant metadata, and sends the RDP to the requestor as well. The redundancy block is also referred to as a “redundancy payload” since it is sent in the payload of the RDP.

The redundancy block may comprise, for example, a bitwise XOR of the data packets in the TARP group. Since the group may comprise data packets of different sizes, in some embodiments the size of the redundancy block is set to the maximal supported packet size. For shorter packets, the XOR calculation regards the remaining bits as zero. The RDP enables the responder to reconstruct any single missing data packet the in group, without requiring retransmission.

The requestor typically generates the redundancy block incrementally, in a streaming manner, while data packets are being transmitted. In an example embodiment, the requestor maintains a “temporary redundancy payload” in memory for each TARP group that is currently being transmitted. Upon transmitting a data packet, the requestor updates the temporary redundancy payload of the relevant TARP group to account for the data packet. After the temporary redundancy payload has been updated to account for the last data packet in the TARP group, the requestor generates and sends the RDP.

In a similar manner, the responder typically maintains a temporary redundancy payload for each TARP group that was not yet fully received. Upon receiving a packet (data packet or RDP) belonging to a certain TARP group, the responder updates the temporary redundancy payload of the group to account for the received packet. If all the data packets in the groups are received before the RDP, the responder may discard the RDP. Otherwise, upon receiving all the data packets in the group except one (for the case of a single RDP per TARP group), and the RDP, the responder reconstructs the missing data packet from the temporary redundancy payload.

Various implementations, variations and extensions of TARP are described herein. For example, TARP may be enabled for certain connections (e.g., for certain Queue Pairs (QPs) in the requestor and the responder) and disabled for other connections (e. g., other QPs). The TARP group size may be fixed or variable. The mapping between data packets and TARP groups may be defined in terms of Packet Serial Numbers (PSNs) of the data packets.

As another example, the embodiments described herein refer mainly to packets that are sent from a requestor (a transaction requestor) to a responder (a transaction responder). Additionally, or alternatively, TARP can be applied to packets sent from the responder to the requestor, e.g., read response packets.

In some embodiments, a variant of TARP uses multiple RDPS per TARP group. For a given TARP group, the requestor calculates each RDP over a different subset of the data packets in the group. This TARP variant enables the responder to mitigate the loss of multiple data packets in a group. Techniques for selecting the subsets of data packets, and for reconstructing missing data packets using the multiple RDPs, are described.

### System Description

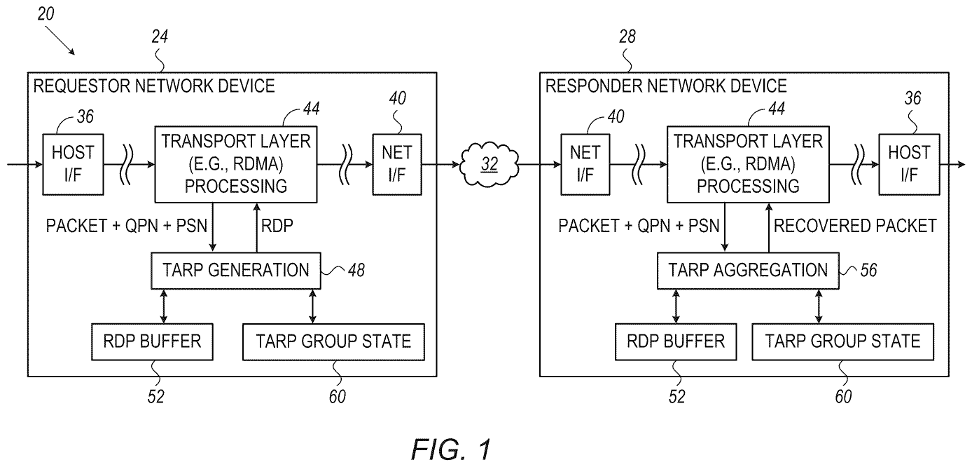

FIG. 1 is a block diagram that schematically illustrates a communication system 20 comprising network devices that use TARP, in accordance with an embodiment that is described herein. System 20 comprises a network device 24 that serves as a requestor, and a network device 28 that serves as a responder. Devices 24 and 28 serve respective hosts (not seen in the figure) and communicate with one another over a network 32.

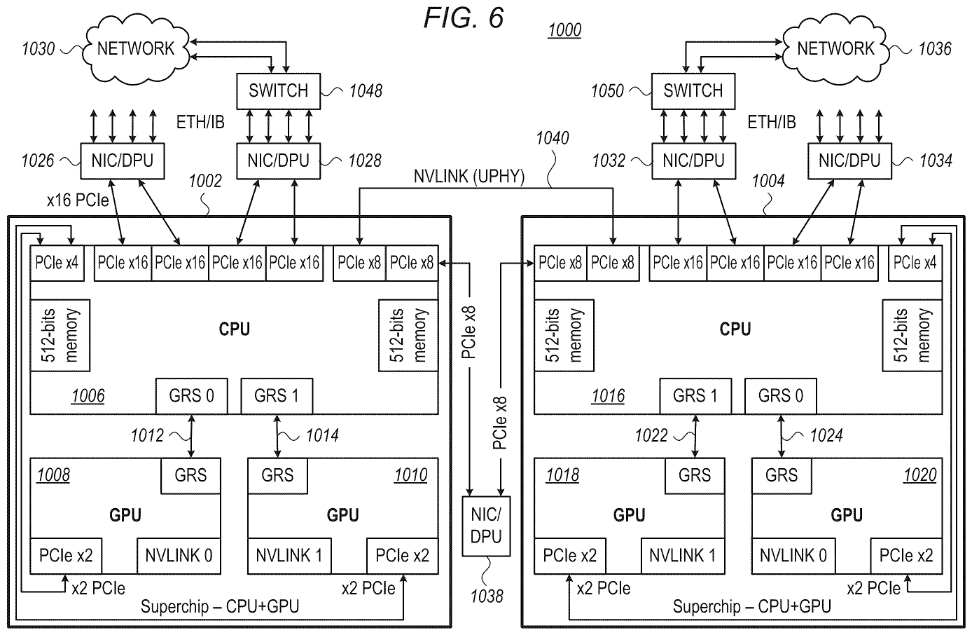

The simplified example of FIG. 1 illustrates only two network devices, for clarity. Real-life systems typically comprise a large number of network devices. Communication systems such as system 20 may be used for implementing a data center, a High-Performance Computing (HPC) cluster, or any other suitable system. An example system use case is illustrated in FIG. 6 below.

Network devices 24 and 28 may comprise, for example, NICs, HCAs or DPUs. Network 32 may comprise, for example, an Ethernet or IB network. A given network device typically serves as a requestor for some connections and a responder for other connections. For clarity, the figure focuses on the elements relating to packet transmission in the requestor, and on the elements relating to packet reception in the responder.

Requestor 24 comprises a host interface (I/F) 36 for communicating with its host or hosts, a network interface 40 (also referred to as a port) for communicating over network 32, and a packet pipeline for transmitting packets to network 32. Among other elements, the packet pipeline of requestor 24 comprises transport-layer processing circuitry 44 that carries out the various transport layer processing tasks of the requestor. Circuitry 44 is also referred to herein as “transport circuitry” for brevity. In the present example, transport circuitry 44 implements the RDMA protocol stack.

Requestor 24 further comprises TARP generation circuitry 48 that is coupled to transport circuitry 44. TARP generation circuitry 48 is also referred to herein as “TARP generator” or “redundancy generator”. TARP redundancy packets (RDPs) generator 48 generates TARP over groups of data packets, in a streaming manner, as will be described in detail below. Requestor 24 also comprises a memory referred to as an RDP buffer 52 for temporary storage of redundancy blocks, RDPs and/or other group state memory 60 relevant information, and a TARP for storing the current state of each active TARP group.

Responder 28 comprises a host interface 36 for communicating with the host or hosts served by the responder, a network interface 40 (also referred to as a network 32, and a packet port) for communicating pipeline for receiving packets from network 32. Among other elements, the packet pipeline of responder 28 comprises transport-layer processing circuitry 44 (also referred to herein as “transport circuitry”) that carries out the various transport layer processing tasks of the responder. In the present example, transport circuitry 44 implements the RDMA protocol stack.

Responder 28 further comprises TARP aggregation circuitry 56 (also referred to herein as “TARP aggregator” or “redundancy reconstructor”) coupled to transport circuitry 44. TARP aggregator 56 reconstructs lost data packets using RDPs received from requestor 24. Requestor 28 further comprises an RDP buffer 52 for temporary storage of redundancy blocks, RDPs and/or other relevant information, and a TARP group state memory 60 for storing the current state of each active TARP group. The packet reconstruction process, including the use of RDP buffer and TARP group state 60, is described in detail below.

The configurations of system 20 and network devices 24 and 28, as illustrated in FIG. 1, are example configurations chosen purely for the sake of conceptual clarity. In alternative embodiments, any other suitable configuration can be used.

Network devices 24 and 28 may be implemented using suitable hardware, such as in one or more Application-Specific Integrated Circuits (ASICs) or Field-Programmable Gate Arrays (FPGAs), using software, using hardware, or using a combination of hardware and software elements. RDP buffers 52 and TARP group state 60 may be implemented in any suitable memory, e. g., Random Access Memory (RAM). Elements that are not mandatory for understanding of the disclosed techniques have been omitted from the figure for the sake of clarity.

In some embodiments, some network device functions described herein may be implemented in a general-purpose processor, which is programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

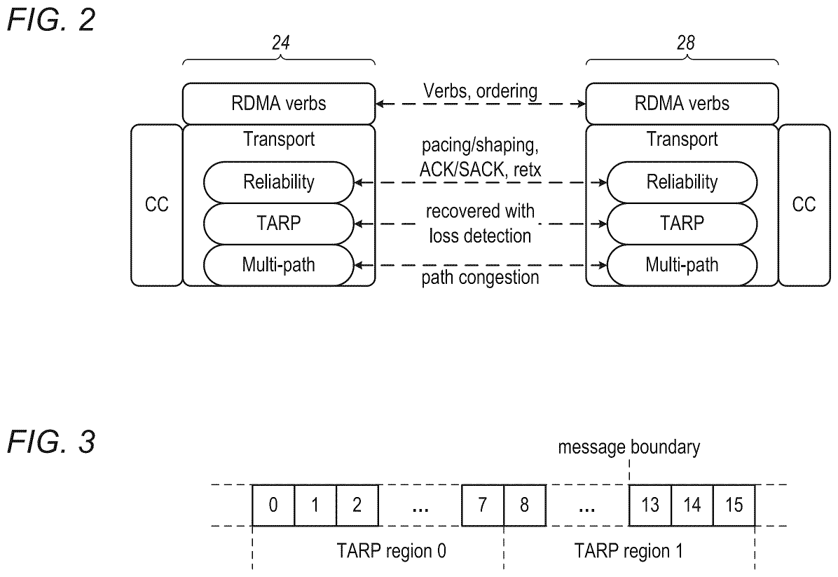

FIG. 2 is a diagram that schematically illustrates integration of TARP in the transport layer processing of requestor network device 24 and responder network device 28, in accordance with an embodiment that is described herein. As seen, TARP is implemented as a sub-layer in the stack of sub-layers making up the transport layer.

In the present example the TARP sub-layer is implemented above the multi-path sub-layer and below the reliability sub-layer. Using this order, the existing RDMA reliability sub-layer (including acknowledgement and retransmission mechanisms) can be used to mitigate any remaining packet loss that TARP failed to resolve. The RDMA reliability sub-layer is unaware of the packet recovery carried out by the TARP sub-layer. The TARP recovery mechanism is typically agnostic to multi-pathing that may be used by the multi-path sub-layer.

### Tarp Connections/Qps, Groups/Regions, Tarp States

Typically, requestor 24 handles one or more active connections with one or more responders 28 at a given time. For each active connection, the requestor maintains a respective Queue Pair (QP) for posting work requests and completion notifications. Similarly, responder 28 may handle one or more active connections with one or more requestors 24 at a given time. The responder maintains a respective QP for each active connection, for posting work requests 1 and completion notifications. The terms “connection” and “QP” are used interchangeably herein.

In some embodiments, TARP is enabled for certain connections (QPs) and disabled for other connections (QPs). The decision whether to enable or disable TARP for a given QP is typically made by requestor 24. Responder 28 learns whether TARP is enabled or disabled for a particular QP by checking whether or not RDPs are received in that QP. If no RDPs are received, the responder will not apply the disclosed techniques. Alternatively, the requestor may send explicit messages to the responder, indicating which QPs are TARP-enabled and/or which QPs are TARP-disabled.

Within a given connection, the requestor typically assigns sequential Packet Serial Numbers (PSNs) to the data packets being transmitted. Conventionally, the PSNs are used by the requestor and the responder to detect missing data packets, request and perform retransmissions, and send acknowledgements. In some embodiments, the PSNs are also used for defining “TARP groups” (also referred to as “TARP regions”). In the present context, the term “TARP group” or “TARP region” refers to a defined group of data packets (identified by their PSNs) that are protected by a respective RDP. (An extension to this technique, in which a TARP group is protected by two or more RDPs, is described further below.)

FIG. 3 is a diagram that schematically illustrates a sequence of data packets of a certain connection, divided into TARP regions, in accordance with an embodiment that is described herein. In the present example, the packets having PSNs {0, 1, 2, . . . 7} are defined as TARP region 0, the packets having PSNs {8, 9, . . . 15} are defined as TARP region 1, and so on.

In the example of FIG. 3, the TARP regions are equal in size (in the number of data packets), and each TARP region comprises a consecutive group of data packets in the sequence. Alternatively, TARP regions may differ in size from one another. A TARP region may comprise non-consecutive data packets having non-consecutive PSNs. The number of data packets per TARP group can be set to any suitable value, e.g., four or eight.

In some embodiments, the partitioning of the data packets into TARP regions is independent of RDMA message boundaries. As seen in FIG. 2 above, the sub-layer of RDMA verbs is implemented on top of the transport layer. The TARP sub-layer operates at the level of data packets, and is typically agnostic to the boundaries between RDMA messages. In FIG. 3, for example, the data packet whose PSN=12 is the last data packet in an RDMA message, and the data packet whose PSN=13 is the first data packet in a subsequent RDMA message. The boundary between the RDMA messages falls within TARP region 1. Thus, the RDP of TARP region 1 will be calculated over data packets belonging to both RDMA messages.

Typically, both requestor 24 and responder 28 save state information 60 for each QP in which TARP is enabled. Typically, both the requestor and the responder may handle multiple TARP-enabled QPs concurrently, using the respective states 60 of these QPs.

In some embodiments, state 60 of a TARP-enabled QP in requestor 24 comprises the following:
The number of PSNs per TARP group.
The PSN offset for the next redundancy calculation (i.e., the number of remaining data packets to transmit before generation of the next RDP).
The start PSN of the current TARP group.
The number of data packets already included in the current redundancy payload.
The content of the current redundancy payload (in buffer 52).

The first two items on the list above are global, i.e., not specific to any given TARP group. The last three items above are specific to the TARP group that is currently being processed. These items may be discarded if necessary, in which case the TARP calculations are aborted for the current TARP group. For example, if state 60 for a certain QP is lost for any reason, no RDP will be generated for the current TARP group, and TARP will resume at the beginning of the next TARP group. In an embodiment, some RDPs may be purely informative, i.e., sent without a redundancy payload, as noted above.

In some embodiments, state 60 of a TARP-enabled QP in responder 28 comprises the following:
The number of PSNs per TARP group.
The PSN offset for the next redundancy calculation.
The start PSN of the current TARP group.
The number of packets already included in the current redundancy payload.
The content of the current redundancy payload (in buffer 52).

In the responder, too, the first two items on the list above are global, and the last three items are specific to the TARP group that is currently being processed. The group-specific items may be discarded if necessary, in which case the TARP calculations are aborted for the current TARP group.

In some embodiments, TARP is used for RDMA write and RDMA send commands, not for RDMA read commands. In these embodiments, redundancy generator 48 and redundancy aggregator 56 include in the current TARP group data packets associated with RDMA write or send commands, and exclude from the group data packets associated with RDMA read commands. Retransmitted data packets are also typically excluded from TARP.

### Requestor and Responder Flows

### Requestor Flow

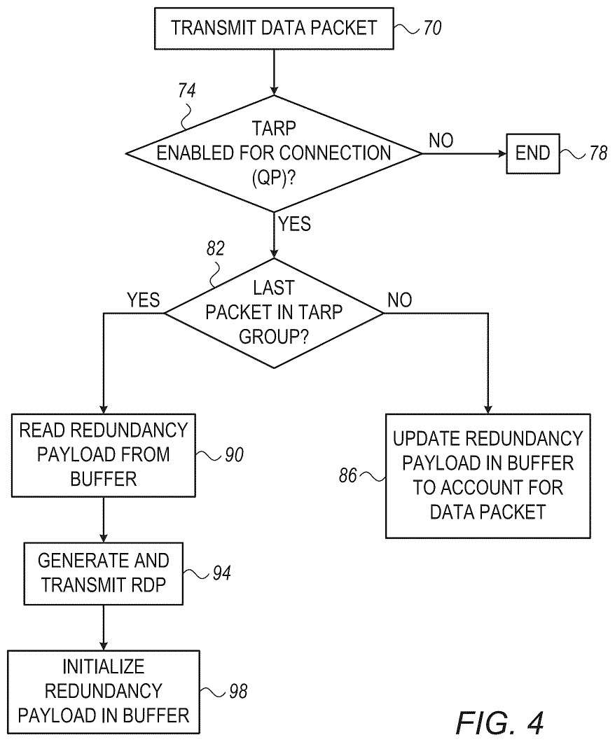

FIG. 4 is a flow chart that schematically illustrates a method for packet transmission using TARP, in accordance with an embodiment that is described herein. The method is carried out by a requestor network device, e.g., requestor 24 of FIG. 1. The requestor typically repeats the flow of FIG. 4 for every data packet being transmitted. For ease of explanation, the example of FIG. 4 refers to an implementation that uses a single RDP per TARP group. Alternative embodiments that use multiple RDPs per TARP group are described further below.

The method begins with the packet pipeline of requestor 24 transmitting a data packet over network 32 to responder 28 via port 40, at a data packet transmission operation 70. As part of the transmission operation, transport circuitry 44 of requestor 24 provides TARP generator 48 with (i) the data packet, (ii) the QP number (QPN) associated with the data packet, which identifies the connection to which the data packet belongs, and (iii) the PSN of the data packet.

At a TARP enablement checking operation 74, TARP generator 48 checks, based on the QPN, whether TARP is enabled or disabled for the QP in question. If TARP is disabled, the method ends (for this particular data packet) at a termination operation 78.

If TARP is enabled for the QP of the data packet, the method proceeds. Since TARP is enabled for the QP of the data packet, the data packet is associated with a certain TARP group. A temporary redundancy payload is maintained for this TARP in RDP buffer 52. The redundancy payload is assumed to be initialized to all-zeros before starting transmission of packets belonging to the TARP group.

At a last packet checking operation 82, TARP generator 48 checks whether the data packet is the last data packet to be transmitted in a TARP group. If the data packet is not the last data packet in its TARP group, TARP generator 48 updates the redundancy block (redundancy payload) of the TARP group in RDP buffer 52 to account for the data packet, at an updating operation 86.

The updating operation typically comprises (i) reading the redundancy payload from RDP buffer 52, (ii) calculating a bitwise XOR between the redundancy payload and the data packet, and (iii) writing the XOR result as an updated redundancy payload to RDP buffer 52. In the updating operation, TARP generator 48 typically includes the entire data packet including all headers and payload, so as to enable full reconstruction of the data packet by the responder.

Typically, the size of the redundancy payload in RDP buffer 52 is set to the maximal expected data packet size. If the data packet is smaller than the maximal size, TARP generator 48 typically sets the remaining bits, up to the maximal size, to zero, and then performs the bitwise XOR. If, in a given TARP group, none of the packets reaches the maximal size, TARP generator 48 may set bits to zero only up to the size of the largest packet in the TART group.

Reference is now made back to last packet checking operation 82. If the data packet is found to be the last data packet in its TARP group, TARP generator 48 reads the redundancy payload from RDP buffer 52, at a buffer readout operation 90. TARP generator 48 generates an RDP containing the redundancy payload, at an RDP generation operation 94, and provides the RDP to the packet pipeline for transmission to the responder.

In addition to the redundancy payload, TARP generator 48 typically generates an RDP header for the RDP. The RDP header may comprise any suitable metadata or other information, for example the following:
An opcode identifying the packet as an RDP.
An indication of whether the RDP contains redundancy data or not. (An RDP that does not contain redundancy data can be used signaling to from the requestor to the responder, indicating that TARP is enabled for the QP in question. The responder may use this indication to initialize state 60 for the QP.)
QP number (QPN).
The size of the redundancy payloads used on this QP.
The size of the redundancy payload (i.e., the size of the largest data packet in the TARP group).
Encoded length of each data packet in the TARP group.

The above parameters assume that the TARP group spans a consecutive sequence of PSNs. To support TARP groups having non-consecutive PSNS, additional information may need to be added to the RDP header or to the TARP connection parameters.

In some embodiments, the RDP is formatted as a transport packet (in which case the transport layer should ignore it). In these embodiments, the RDP may comprise a Base Transport Header (BTH) indicating the QPN and PSN of the RDP. In other embodiments, the RDP is formatted as a Management Datagrams (MAD) packet. Alternatively, any other suitable packet format can be used.

At a resetting stage 98, TARP generator 48 then resets the redundancy payload of the QP in buffer 52 to all-zeros, in preparation for handling the next TARP region of that QP.

### Responder Flow

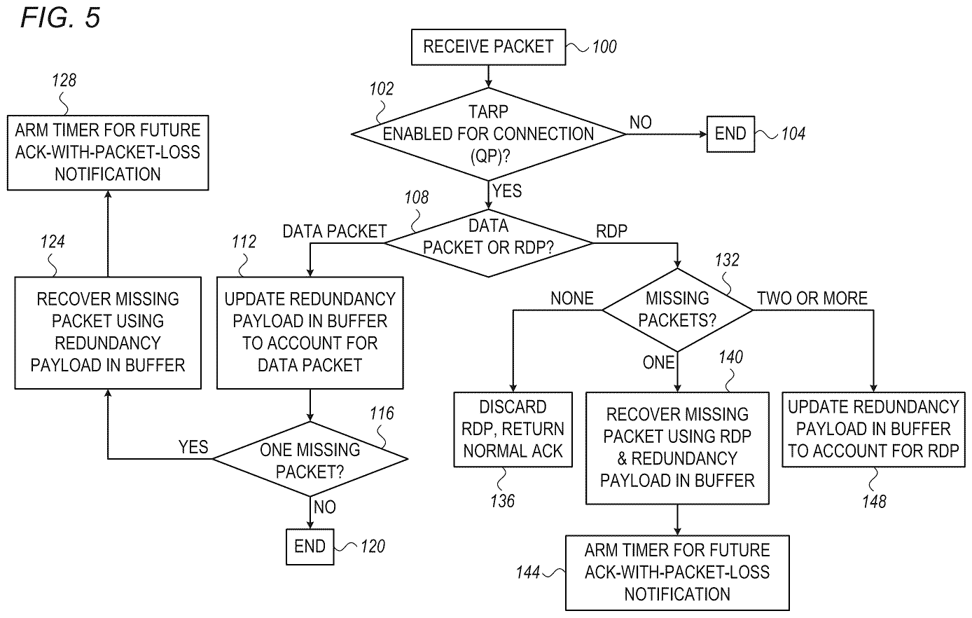

FIG. 5 is a flow chart that schematically illustrates a method for packet reception using TARP, in accordance with an embodiment that is described herein. The method is carried out by a responder network device, e.g., responder 28 of FIG. 1. The responder typically repeats the flow of FIG. 5 for every packet (data packet or RDP) being received. As in FIG. 4 above, the non-limiting example of FIG. 5 refers to an implementation that uses a single RDP per TARP group, for ease of explanation.

The method begins with the packet pipeline of responder 28 receiving a packet (data packet or RDP) from network 32 via port 40, at a packet reception operation 100. As part of the reception operation, transport circuitry 44 of responder 28 provides TARP aggregator 56 with (i) the packet, (ii) the QPN associated with the packet, and (iii) the PSN of the packet. Based on this information, TARP aggregator 56 can associate the received packet with at most one TARP group, and possibly to no TARP group (e.g., if TARP is not enabled for the QP of the packet). More generally, TARP aggregator 56 can associate a received packet with a TARP group based on any other suitable identifier or identifiers extracted from the received packet.

At a TARP enablement checking operation 102, TARP aggregator 56 checks, based on the QPN, whether TARP is enabled or disabled for the QP to which the packet belongs. If TARP is disabled, the method ends (for this particular packet) at a termination operation 104.

If TARP is enabled for the QP of the packet, the method proceeds. Since TARP is enabled for the QP of the packet, the packet is associated with a certain TARP group. A temporary redundancy payload is maintained for this TARP in RDP buffer 52 of responder 28. The redundancy payload is assumed to be initialized to all-zeros before starting reception of packets belonging to the TARP group.

At a packet type checking operation 108, TARP aggregator 56 checks whether the received packet is a data packet or an RDP. If the received packet is a data packet, TARP aggregator 56 updates the redundancy payload of the TARP group in buffer 52 to account for the data packet, at an updating operation 112.

The updating operation typically comprises (i) reading the redundancy payload from RDP buffer 52, (ii) calculating a bitwise XOR between the redundancy payload and the data packet, and (iii) writing the XOR result as an updated redundancy payload to RDP buffer 52. In the updating operation, TARP aggregator 56 typically includes the entire data packet including all headers and payload.

The size of the redundancy payload in RDP buffer 52 is typically set to the maximal expected data packet size. If the data packet is smaller than the maximal size, TARP aggregator 56 typically sets the remaining bits, up to the maximal size, to zero, and then performs the bitwise XOR.

At a missing packet checking operation 116, TARP aggregator 56 checks whether exactly a single data packet is currently missing (from among the data packets of the TARP group and the RDP). In other words, TARP aggregator 56 checks whether (i) the RDP and (ii) all data packets except one, have arrived for the TARP group in question. If not, the method ends (for this particular packet) at a termination operation 120.

If a single data packet is missing, TARP aggregator 56 reconstructs the missing data packet using the redundancy payload in buffer 52, at a reconstruction operation 124. When only a single data packet is missing, the redundancy buffer holds a bitwise XOR of (i) the RDP and (ii) the data packets that were received so far for the TARP region. This bitwise XOR result is equal to the missing data packet (possibly with zero padding).

TARP aggregator 56 then delivers the recovered data packet to transport circuitry 44 in the packet pipeline of the responder. The packet pipeline continues processing of the recovered data packet, similarly to the processing of other data packets. As noted above, higher layers are typically unaware that this data packet has been recovered using TARP.

In some embodiments, although the missing data packet has been recovered, TARP aggregator 56 in responder 28 notifies requestor 24 that packet loss has occurred. This notification, referred to as “ACK-with-packet-loss”, indicates to the requestor that a packet was lost, but that no retransmission is needed. The notification is useful, for example, for tuning a Congestion Control (CC) mechanism or other mechanisms in the requestor. One of the parameters that can be tuned by the requestor's CC mechanism is the size of the TARP group for the QP in question. When packet dropping is rare, the TARP group can be set to a large value (reducing network overhead but providing more modest recovery capability). When packet dropping is more frequent, the TARP group can be set to a smaller value (increasing network overhead but providing improved recovery capability).

In some embodiments, before issuing the ACK-with-packet-loss notification, TARP aggregator 56 waits for a defined time period, in case the data packet in question was not lost but only delayed.

In an embodiment, TARP aggregator 56 arms a timer to count the defined time period, at a timer arming operation 128. If the missing data packet arrives before the timer expires, no notification is sent (or a normal ACK is sent). Otherwise, TARP aggregator 56 sends an ACK-with-packet-loss notification to requestor 24.

Reference is now made back to packet type checking operation 108. If the received packet is an RDP, TARP generator 56 checks how many data packet of the TARP group are missing at this point, at a missing packet counting operation 132.

If no data packet is missing in the TARP group, there is no need for recovery, and TARP aggregator discards the RDP, at a discarding operation 136. If exactly one data packet is missing, TARP aggregator recovers the missing data packet using the RDP and the temporary redundancy payload of the TARP group, at a recovery operation 140. Typically, TARP aggregator 56 performs a bitwise XOR between the RDP and the redundancy payload, to produce the missing data packet (up to possible zero padding). TARP aggregator 56 delivers the recovered data packet to transport circuitry 44 in the packet pipeline of responder r 28. At a timer arming operation 144 (similar to operation 128 described above) TARP aggregator 56 arms the timer for a possible future ACK-with-packet-loss notification.

If two or more data packets are missing, TARP aggregator 56 updates the redundancy payload in buffer 52 to account for the RDP, at a redundancy updating operation 148.

The requestor and responder flows of FIGS. 4 and 5 are example flows that are depicted purely for the sake of conceptual clarity. Requestor 24 and responder 28 may use any other suitable flows in alternative embodiments.

Tarp with Multiple Rdps Per Tarp Group

In the embodiments described up to this point, a single RDP is generated for each TARP region, thereby enabling recovery of a single lost data packet per TARP group. In alternative embodiments described in this section, TARP generator 48 in requestor 24 generates multiple RDPs per TARP group, and TARP aggregator 56 in responder 28 uses the multiple RDPs to recover multiple lost data packets in a TARP group.

In the description that follows, the number of data packets in a TARP group is denoted k, the number of RDPs in a TARP group is denoted r, and the total number of packets (data packets and RDPs) is denoted n, n=k+r. In these embodiments, once more than k packets out of the n=k+r packets have been received successfully, the responder can recover the remaining data packets.

In these embodiments, TARP generator 48 maintains r temporary redundancy payloads (redundancy blocks) per TARP group in RDP buffer 52, and updates the redundancy payloads as data packets are streamed via the packet pipeline of requestor 24. Once the redundancy payloads are ready, TARP generator 48 generates r RDPs, each comprising a respective redundancy payload, and delivers the RDPs to the pipeline of requestor 24 for transmission to responder 28.

In responder 28, TARP aggregator 56 also maintains r temporary redundancy payloads (redundancy blocks) per TARP group in RDP buffer 52. TARP aggregator 56 updates the redundancy payloads as data packets and RDPs are received and streamed via the packet pipeline of the responder. When the r RDPs and at least k-r of the data packets are received, TARP aggregator 56 uses these RDPs and data packets to recover the remaining data packets in the TARP group. TARP aggregator 56 delivers the recovered data packets to the packet pipeline of responder 28.

Other features of TARP (e.g., enabling/disabling TARP per individual QP, zero padding of redundancy payloads to account for differing data packet sizes, etc.) are similar to the single-RDP embodiments described above.

In some embodiments, the r redundancy payloads are generated from a generation matrix G of a (n, r) Cyclic Redundancy Check (CRC) code. Example techniques for deriving matrix G from the generator polynomial of a CRC can be found, for example, in “A Novel Programmable Parallel CRC Circuit,” Grymel and Furber, IEEE Transactions on Very Large Scale Integration (VLSI) Systems, volume 19, issue 10, October 2011.

Consider, for example, a (12, 8) CRC scheme derived from the generator polynomial x⁴+x+1. In this example, TARP group comprises eight data packets (k=8) and each four RDPs (r=4), i.e., a total of twelve packets (n=12). TARP generator 48 derives the four redundancy payloads (denoted P_{0:3}) from the eight data packets

$$( denoted {D}_{0 : 7}^{T} = [ {d}_{0} ... {d}_{7} ] )$$

by:

$${P}_{0 : 3} = {G}_{0 : 3 , 0 : 7} * {D}_{0 : 7}$$

$$wherein$$

$${G}_{0 : 3 , 0 : 7} = [ \begin{matrix}1 & 0 & 1 & 0 & 1 & 1 & 0 & 0 \\ 1 & 1 & 0 & 1 & 0 & 1 & 1 & 0 \\ 1 & 1 & 1 & 0 & 1 & 0 & 1 & 1 \\ 0 & 1 & 0 & 1 & 1 & 0 & 0 & 1\end{matrix} ]$$

The structure of generator matrix G can be interpreted as follows:
The i^{th} row of the matrix (i0 . . . 3) corresponds to the i^{th} redundancy payload.
The j^{th} column of the matrix (j=0 . . . 7) corresponds to the j^{th} data packet.
Each of the four redundancy payloads is constructed by XORing a respective different subset of the eight data packets.
Matrix element G_{i,j} indicates whether the i^{th} redundancy payload should be updated to account for the j^{th} data packet (i.e., whether the i^{th} redundancy payload should be XORed with the j^{th} data packet). If the matrix element is equal to “1”, the redundancy payload should be updated. If the matrix element is equal to “0”, the redundancy payload should not be updated.
Equivalently, the matrix elements G_{i,j} along the i^{th} row of matrix G indicate the indices of the redundancy payloads that participate in the i^{th} redundancy payload.

Thus, in an embodiment, when transmitting the j^{th} data packet, TARP generator 48 XORs the j^{th} data packet with the redundancy payloads indicated by the j^{th} column of matrix G. For example, when transmitting the first data packet (corresponding to the left-most column of matrix G, j=0), TARP generator 48 updates redundancy payloads 0, 1 and 2, but not 3.

In responder 28, TARP aggregator 56 accumulates four redundancy payloads denoted

$${C}_{0 : 3}^{T} = [ {c}_{0} ... {c}_{3} ] ,$$

according to a parity check matrix of the form:

$${H}_{0 : 3 , 0 : 11} = ( {G}_{0 : 3 , 0 : 11} \vert \begin{matrix}1 & 0 & 0 & 0 \\ 0 & 1 & 0 & 0 \\ 0 & 0 & 1 & 0 \\ 0 & 0 & 0 & 1\end{matrix} )$$

In the context of recovery calculations, the data packets are indexed 0, 1, . . . , 7 and the RDPs are indexed 8, 9, . . . , 11. As seen, in the responder, for recovery, the H matrix has twelve columns (as opposed to eight columns in the H matrix used for generating the RDPs in the requestor).

For every received packet index j (0≤j≤11) of value vⱼ, C_{0:3}\hat{ }=H_{0:3,j}*Vⱼ. In other words, for each redundancy payload i (0≤i≤3), if H_{i,j}==1 then cᵢ=cᵢ\hat{ }vⱼ. For example, when the packet indexed 1 is received, the redundancy payloads indexed 1, 2 and 3 are updated (because column 1, rows 1 through 3 are of value 1 in the H matrix).

When k or more packets of a TARP group (data packets and/or RDPs) are received successfully, TARP aggregator 56 recovers the remaining packets by solving the equation

$${H}_{0 : 3 , 0 : 11} * [ \begin{matrix}{D}_{0 : 7} \\ {P}_{0 : 3}\end{matrix} ] = 0.$$

For example, if the data packets indexed 0, 1, 2 are lost, the above equation is reduced to

$${H}_{: , [ 0 : 3 ]} [ \begin{matrix}{d}_{0} \\ {d}_{1} \\ {d}_{2}\end{matrix} ] + {C}_{0 : 4} = 0$$

$$i . e . ,$$

$$[ \begin{matrix}1 & 0 & 1 \\ 1 & 1 & 0 \\ 1 & 1 & 0 \\ 1 & 0 & 1\end{matrix} ] [ \begin{matrix}{d}_{0} \\ {d}_{1} \\ {d}_{2}\end{matrix} ] = [ \begin{matrix}{c}_{0} \\ {c}_{1} \\ {c}_{2} \\ {c}_{3}\end{matrix} ]$$

This equation can be solved as

$$\{ \begin{matrix}{d}_{0} = {c}_{0} + {c}_{1} + {c}_{2} \\ {d}_{1} = {c}_{0} + {c}_{2} \\ {d}_{2} = {c}_{1} + {c}_{2}\end{matrix}$$

In another example scenario, the loss of data packets 0,1,2,7 is not recoverable, since there is no unique solution to the equation

$$[ \begin{matrix}1 & 0 & 1 & 0 \\ 1 & 1 & 0 & 0 \\ 1 & 1 & 1 & 1 \\ 0 & 1 & 0 & 1\end{matrix} ] * [ \begin{matrix}{d}_{0} \\ {d}_{1} \\ {d}_{2} \\ {d}_{7}\end{matrix} ] = [ \begin{matrix}{c}_{0} \\ {c}_{1} \\ {c}_{2} \\ {c}_{3}\end{matrix} ]$$

In some embodiments, TARP aggregator 56 recovers the lost data packets by solving a set of linear equations using the following process (for an example case in which three data packets indexed 0,1,2 are lost, i.e., L=3):

Step 1: Expand matrix H with a 4-by-4 identity matrix to produce

$$( \begin{matrix}1 & 0 & 1 \\ 1 & 1 & 0 \\ 1 & 1 & 1 \\ 0 & 1 & 0\end{matrix} \vert \begin{matrix}1 & 0 & 0 & 0 \\ 0 & 1 & 0 & 0 \\ 0 & 0 & 1 & 0 \\ 0 & 0 & 0 & 1\end{matrix} )$$

Only row swapping and row additions (implemented as bitwise XOR) are permitted from this point.

Step 2: Clear the bottom-left of H in the expanded matrix: For every row i (incremental) in [0, 1, . . . , L−1], perform the following:
1. Find the leading “1” in the row: If H_{i,i}==1, no operation is needed. Otherwise, find a row j≥i in which H_{j,i}==1 and add row j to row i. If this step fails, then the solution is not unique, and the packet loss is irrecoverable.
2. Clear any value “1” in column i for the rows below: For row i<j≤r-1=3, add row i to row j if H_{j,i}==1, yielding

$$( \begin{matrix}1 & 0 & 1 \\ 0 & 1 & 1 \\ 0 & 1 & 0 \\ 0 & 1 & 0\end{matrix} \vert \begin{matrix}1 & 0 & 0 & 0 \\ 1 & 1 & 0 & 0 \\ 1 & 0 & 1 & 0 \\ 0 & 0 & 0 & 1\end{matrix} ) \to ( \begin{matrix}1 & 0 & 1 \\ 0 & 1 & 1 \\ 0 & 0 & 1 \\ 0 & 0 & 1\end{matrix} \vert \begin{matrix}1 & 0 & 0 & 0 \\ 1 & 1 & 0 & 0 \\ 0 & 1 & 1 & 0 \\ 1 & 1 & 0 & 1\end{matrix} )$$

Step 3: Clear the upper-right corner of matrix H in the expanded matrix: for every row i (decremental) in [L-1, L-2, . . . , 1] perform the following: For row 0≤j<i, add row i to row j if H_{j,i}==1, yielding

$$( \begin{matrix}1 & 0 & 1 \\ 0 & 1 & 0 \\ 0 & 0 & 1 \\ 0 & 0 & 1\end{matrix} \vert \begin{matrix}1 & 0 & 0 & 0 \\ 1 & 0 & 1 & 0 \\ 0 & 1 & 1 & 0 \\ 1 & 1 & 0 & 1\end{matrix} ) \to ( \begin{matrix}1 & 0 & 0 \\ 0 & 1 & 0 \\ 0 & 0 & 1 \\ 0 & 0 & 1\end{matrix} \vert \begin{matrix}1 & 1 & 1 & 0 \\ 1 & 0 & 1 & 0 \\ 0 & 1 & 1 & 0 \\ 1 & 1 & 0 & 1\end{matrix} )$$

Step 4: The top L rows of the right-hand part of the expanded matrix is the solution:

$$[ \begin{matrix}{d}_{0} \\ {d}_{1} \\ {d}_{2}\end{matrix} ] = [ \begin{matrix}1 & 1 & 1 & 0 \\ 1 & 0 & 1 & 0 \\ 0 & 1 & 1 & 0\end{matrix} ] [ \begin{matrix}{c}_{0} \\ {c}_{1} \\ {c}_{2} \\ {c}_{3}\end{matrix} ]$$

The coding schemes, numerical values, RDP generation processes and packet recovery processes described above are non-limiting examples that have been chosen purely for the sake of clarity. In alternative embodiments, any other suitable coding schemes, numerical values, RDP generation processes and/or packet recovery processes can be used.

### Example System Use-Case

FIG. 6 is a block diagram that schematically illustrates a computing system 1000, e. g., a data center or a High-Performance Computing (HPC) cluster, in accordance with an embodiment that is described herein. System 1000 comprises a plurality of f subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUS, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036. In the present example, system 1000 comprises a packet switch 1048 that connects NIC/DPU 1028 to network 1030, and a packet switch 1050 that connects NIC/DPU 1032 to network 1036.

The coupling of processing devices through NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 6 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 6, CPU 1006 is coupled to a first NIC/DPU 1026, which is coupled to a network 1030. CPU 1006 is also coupled to a second NIC/DPU 1028, which is coupled to network 1030 via switch 1048. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 6, CPU 1016 is coupled to a first NIC/DPU 1032, which is coupled to a network 1036. CPU 1016 is also coupled to a second NIC/DPU 1034, which is coupled to network 1036 via switch 1050. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, any of the network devices of system 1000, e.g., any of NICs/DPUs 1026, 1028, 1032, 1034 and 1038, may use TARP in accordance with the techniques described herein. The packet switches in FIG. 6 may comprise, for example, Nvidia Quantum-2 switches. The NICs/DPUs in the figure may comprise, for example, Nvidia Bluefield DPUs.

Although the embodiments described herein mainly address east-west traffic, the methods and systems described herein can also be used in north-south traffic, such as traffic to and from storage devices.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A network device, comprising:
a port, to connect to a network;
a packet pipeline, to transmit a sequence of data packets to the network via the port; and
a redundancy generator, to:
for a group of the data packets (i) initialize one or more redundancy blocks, then (ii) iteratively update the one or more redundancy blocks in response to the data packets in the group traversing the packet pipeline, and (iii) generate one or more redundancy packets comprising the one or more redundancy blocks; and
transmit the one or more redundancy packets to the network using the packet pipeline.

2. The network device according to claim 1, wherein the redundancy generator is to obtain the data packets from a transport layer of the network device.

3. The network device according to claim 1, wherein the data packets in the group are associated with a given Queue Pair (QP) of the network device.

4. The network device according to claim 1, wherein the redundancy generator is to update multiple sets of redundancy blocks for multiple respective groups of the data packets, including maintaining respective states for the groups.

5. The network device according to claim 1, wherein at least two of the data packets in the group differ in size from one another, and wherein the redundancy generator is to set a size of a redundancy block to be at least a maximal size of the data packets in the group.

6. The network device according to claim 1, wherein the redundancy generator is to specify, in the one or more redundancy packets, respective sizes of the data packets in the group.

7. The network device according to claim 1, wherein the redundancy generator is to include in the group data packets associated with write or send commands, and to exclude from the group data packets associated with read commands.

8. The network device according to claim 1, wherein the one or more redundancy blocks comprise multiple redundancy blocks, and wherein the redundancy generator is to update each of the redundancy blocks in response to a respective, different subset of the data packets in the group.

9. A network device, comprising:
a port, to connect to a network;
a packet pipeline, to receive, from the network via the port, a packet sequence including multiple data packets and one or more redundancy packets; and
a redundancy reconstructor, to perform the following for a group of expected data packets associated with the one or more redundancy packets:
initialize one or more redundancy blocks;
iteratively update the one or more redundancy blocks to account for any received redundancy packet and any received data packet belonging to the group;
upon updating the redundancy blocks to account for the one or more redundancy packets and all but a specified number of one or more remaining data packets in the group, reconstruct the one or more remaining data packets using the one or more redundancy blocks; and
provide the reconstructed one or more remaining data packets to the packet pipeline.

10. The network device according to claim 9, wherein the redundancy reconstructor is to forward the reconstructed one or more remaining data packets to a transport layer of the network device.

11. The network device according to claim 9, wherein the data packets in the group are associated with a given Queue Pair (QP) of the network device.

12. The network device according to claim 9, wherein the redundancy reconstructor is to update multiple sets of redundancy blocks for multiple respective groups of the data packets, including maintaining respective states for the groups.

13. The network device according to claim 12, wherein the redundancy reconstructor is to associate a received data packet with one of the groups based on one or more identifiers extracted from the data packet.

14. The network device according to claim 9, wherein the redundancy reconstructor is to:
extract, from the one or more redundancy packets, sizes of the respective data packets in the group; and
update the one or more redundancy blocks to account for the received data packets depending on the sizes of the data packets.

15. The network device according to claim 9, wherein the one or more redundancy blocks comprise multiple redundancy blocks, and wherein the redundancy reconstructor is to update each of the redundancy blocks in response to a respective, different subset of the data packets in the group.

16. A method, comprising:
transmitting a sequence of data packets to a network using a packet pipeline;
for a group of the data packets (i) initializing one or more redundancy blocks, then (ii) iteratively updating the one or more redundancy blocks in response to the data packets in the group traversing the packet pipeline, and (iii) generating one or more redundancy packets comprising the one or more redundancy blocks; and
transmitting the one or more redundancy packets to the network using the packet pipeline.

17. The method according to claim 16, wherein initializing and updating the redundancy blocks, and generating the redundancy packets, are performed as part of transport-layer processing in a network device.

18. A method, comprising:
using a packet pipeline, receiving from a network a packet sequence including multiple data packets and one or more redundancy packets; and
performing the following for a group of expected data packets associated with the one or more redundancy packets:
initializing one or more redundancy blocks;
iteratively updating the one or more redundancy blocks to account for any received redundancy packet and any received data packet belonging to the group;
upon updating the redundancy blocks to account for the one or more redundancy packets and all but a specified number of one or more remaining data packets in the group, reconstructing the one or more remaining data packets using the one or more redundancy blocks; and
providing the reconstructed one or more remaining data packets to the packet pipeline.

19. The method according to claim 18, wherein initializing and updating the redundancy blocks, and reconstructing the remaining data packets, are performed as part of transport-layer processing in a network device.
